(19) United States
(12) Patent Application Publication
(10) Pub. No.: US 2008/0029535 A1
(43) Pub. Date: Feb. 7, 2008

(54) Tablet cassette with silicon partition

(76) Inventor: Jun Ho Kim, Taegu (KR)

Correspondence Address: PARK LAW FIRM, 3255 WILSHIRE BLVD, SUITE 1110, LOS ANGELES, CA, 90010, US

(21) Appl. No.: 11/498,361

(22) Filed: Aug. 2, 2006

(51) Int. Cl. B23Q 7/12

(52) U.S. Cl. 221/167

(57) ABSTRACT

The tablet cassette with silicon partition includes a cylindrical confiner, a division block, a dropping hole, and silicon partition. The division block is fitted into the cylindrical confiner and has a plurality of slots. The slot is disposed along a circumference of the division block and adapted to contain a tablet. The dropping hole is bored through the bottom of the cylindrical confiner. The silicon partition includes a dividing blade, a partitioning plate, and a fixing edge, and the silicon partition covers the slot of the division block over the dropping hole. The silicon partition prevents tablets other than the confined tablet in the slot of the division block from entering into the slot, and bumps elastically the tablet at a side edge of the silicon partition to prevent the tablet from being damaged.

### BACKGROUND OF THE INVENTION

The present invention relates to a tablet cassette with silicon partition.

More particularly, this invention relates to a tablet cassette that facilitates the separation of tablet one by one into the slot of the division block.

Tablet cassette is an indispensable tool in the pharmacy industry. It seems the only way to handle, separate, and package the vast flow of millions of tablets for the patients.

In the traditional tablet cassette, however, the flow of the tablets were blocked unexpectedly in the middle of the line of motion of the tablets, especially when the tablet drops into a slot of the division block, in which the tablet is clogged around the partition over the slot of the division block. Also, the tablets get damaged by the collision with a sharp edge of the partition.

Accordingly, a need for a tablet cassette with silicon partition has been present for a long time considering the wide range of usage. This invention is directed to solve these problems and satisfy the long-felt need.

### SUMMARY OF THE INVENTION

The present invention contrives to solve the disadvantages of the prior art.

An objective of the invention is to provide a tablet cassette with a silicon partition.

Another object of the invention is to provide a tablet cassette that prevents tablets from being damaged by the partition.

Still another object of the invention is to provide a tablet cassette that facilitates separating tablets one by one into the slot without clogging and damaging.

A tablet cassette with silicon partition includes a cylindrical confiner, a division block, a dropping hole, and a flexible partition.

The cylindrical confiner has a bottom wall and a side wall.

The division block is fitted into the cylindrical confiner and has a plurality of slots. The slot is disposed along a circumference of the division block and adapted to contain a tablet of a predetermined size.

The dropping hole is bored through the bottom wall of the cylindrical confiner for passing the tablet through.

The flexible partition with substantially contiguous upper and lower surfaces includes a dividing blade, a partitioning plate, and a fixing edge, and the flexible partition covers the slot of the division block over the dropping hole.

The flexible partition prevents tablets other than the confined tablet in the slot of the division block from entering into the slot, and the silicon partition bumps elastically the tablet at a side edge of the silicon partition to prevent the tablet from being damaged.

The flexible partition may include a silicon partition.

The division block has the shape of cone, and the division block includes a rotational axis, a bottom wall, and a conical top wall.

The conical top wall has a predetermined radial groove for facilitating dividing the downhill movement of the tablet.

The size of slot of the division block is determined by the size of the tablet. The shape of slot of the division block is determined by the shape of the tablet.

The size and the shape of the dropping hole are determined by the size and the shape of the slot of the division block.

The dividing blade of the silicon partition has a cross-sectional shape of wedge for facilitating the vertical separation of the tablets down-poured from the above.

The dividing blade is elastic enough to prevent the tablet from falling into the slot below the dividing blade, and the dividing blade is flexible enough to prevent the tablet from being damaged from collision.

The inner edge of the dividing blade is circular following the inner circumferential line of the slot of the division block.

The thickness of the partitioning plate of the silicon partition is determined by the downward pressure of the tablets in the cylindrical confiner. The thickness of the partitioning plate is determined by a predetermined stiffness for disposing the partitioning plate horizontally.

The thickness of the partitioning plate is approximately from 1.5 to 2.0 millimeter.

The fixing edge has a cross-sectional shape of wedge.

The dividing blade, the partitioning plate, and the fixing blade are made of silicon. The dividing blade, the partitioning plate, and the fixing blade are integrated into one.

The division block revolves with a given angular velocity. The angular velocity of the division block is controlled.

The division block further includes a inter-slot barrier. The width of the inter-slot barrier is controlled by the size of the tablet.

The thickness of the bottom wall of the division block is determined by the size and the shape of the tablet.

The silicon partition is disposed on the inner wall of the cylindrical confiner.

The tablet cassette may further include a partition holder for holding the silicon partition. The partition holder includes a holding slit for holding the silicon partition and a fixing device for fixing the partition holder to the wall of the cylindrical confiner.

In a second embodiment of the invention, the silicon partition further includes a comb structure along the dividing blade. The comb structure reduces the stiffness of the dividing blade, which prevents the extra tablets from falling into the occupied slot of the division block and from being damaged by clogging and collision.

In a third embodiment of the invention, the top surface of the dividing blade and the partitioning plate include a plurality of bumps of a predetermined size for damping the collision between the tablet and the dividing blade and the partitioning plate and for increasing the collision area, wherein the predetermined size of the bumps are determined by the size and shape of the tablet.

In a fourth embodiment of the invention, the top surface of the dividing blade and the partitioning plate include a plurality of oblong bumps in the radial direction of the division block for damping the collision between the tablet and the dividing blade and the partitioning plate and for increasing the collision area.

In another embodiment, the silicon partition may cover at least a portion of the slot of the division block over the dropping hole.

The advantages of the present invention are: (1) the tablet cassette prevents the tablet from being damaged during the separation and dropping process; (2) the tablet cassette facilitates the separation process thanks to the elastic property of the silicon partition.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a cross-sectional view showing a tablet cassette with silicon partition of a first embodiment according to the invention;

FIG. 2 is a partial exploded view of the tablet cassette according to the first embodiment;

FIG. 3 is a perspective view of the assembled silicon partition and partition holder according to the first embodiment;

FIG. 4 is a partial enlarged cross-sectional view of the tablet cassette in use according to the first embodiment;

FIG. 5 is a perspective view of a silicon partition of a second embodiment according to the invention;

FIG. 6 is a perspective view of a silicon partition of a third embodiment according to the invention;

FIG. 7 is a perspective view of a silicon partition of a fourth embodiment according to the invention;

FIG. 8 is a perspective view of the assembled silicon partition and partition holder along with a holder cap;

FIG. 9 is a partial cross-sectional view of FIG. 8 with a holder cap assembled;

FIG. 10 is a perspective view of a division block according to the invention;

FIG. 11 is a side plan view of FIG. 10; and

FIG. 12 is a partial enlarged cross-sectional view of the tablet cassette with a deeper slot.

### DETAILED DESCRIPTION OF THE INVENTION

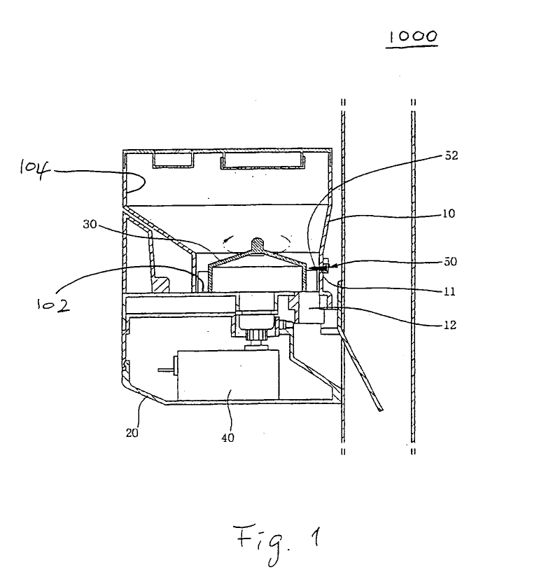

FIGS. 1-4 and 8-11 show a first embodiment of the invention.

FIG. 1 shows a cross-sectional view of a tablet cassette 1000 according to the present invention.

The tablet cassette 1000 with silicon partition includes a cylindrical confiner 10, a division block 30, a dropping hole 12, and a flexible partition 52.

The cylindrical confiner 10 has a bottom wall 102 and a side wall 104.

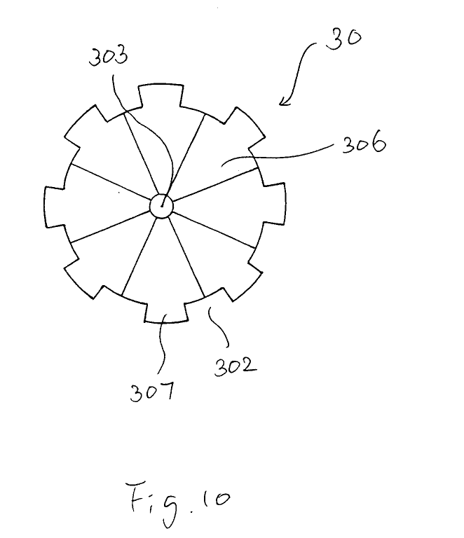

The division block 30 is fitted into the cylindrical confiner 10 and has a plurality of slots 302 as shown in FIG. 10. The slot 302 is disposed along a circumference of the division block 30 and adapted to contain a tablet of a predetermined size.

The dropping hole 12 is bored through the bottom wall 102 of the cylindrical confiner 10 for passing the tablet through.

The flexible partition 52 with substantially contiguous upper and lower surfaces includes a dividing blade 523, a partitioning plate 527, and a fixing edge 521, and the flexible partition 52 covers the slot 302 of the division block 30 over the dropping hole 12.

The flexible partition 52 includes a silicon partition.

The silicon partition 52 prevents tablets other than the confined tablet in the slot 302 of the division block 30 from entering into the slot 302, and the silicon partition 52 bumps elastically the tablet at a side edge of the silicon partition 52 to prevent the tablet from being damaged.

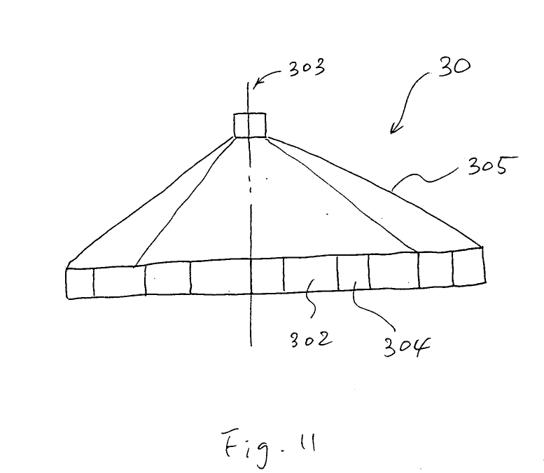

The division block 30 has the shape of cone, and the division block 30 includes a rotational axis 303, a bottom wall 304, and a conical top wall 305 as shown in FIG. 10 and FIG. 11.

The conical top wall 305 has a predetermined radial groove 306 for facilitating dividing the downhill movement of the tablet.

The size of slot 302 of the division block 30 is determined by the size of the tablet. The shape of slot 302 of the division block 30 is determined by the shape of the tablet.

The size and the shape of the dropping hole 12 are determined by the size and the shape of the slot 302 of the division block 30.

The dividing blade 523 of the silicon partition 52 has a cross-sectional shape of wedge for facilitating the vertical separation of the tablets down-poured from the above.

The dividing blade 523 is elastic enough to prevent the tablet from falling into the slot 302 below the dividing blade 523, and the dividing blade 523 is flexible enough to prevent the tablet from being damaged from collision.

The inner edge 522 of the dividing blade 523 is circular following the inner circumferential line of the slot 302 of the division block 30.

The thickness of the partitioning plate 527 of the silicon partition 52 is determined by the downward pressure of the tablets in the cylindrical confiner 10. The thickness of the partitioning plate 527 is also determined by a predetermined stiffness for disposing the partitioning plate 527 horizontally.

The thickness of the partitioning plate 527 is approximately from 1.5 to 2.0 millimeter.

The fixing edge 521 has a cross-sectional shape of wedge.

The dividing blade 523, the partitioning plate 527, and the fixing blade 521 are made of silicon. The dividing blade 523, the partitioning plate 527, and the fixing blade 521 are integrated into one.

The division block 30 revolves with a given angular velocity. The angular velocity of the division block 30 is controlled to adjust the amount of tablets through the dropping hole 12.

The division block 30 further includes a inter-slot barrier 307. The width of the inter-slot barrier 307 is controlled by the size of the tablet.

The thickness of the bottom wall 304 of the division block 30 is determined by the size and the shape of the tablet.

The silicon partition 52 is disposed on the inner wall 104 of the cylindrical confiner 10.

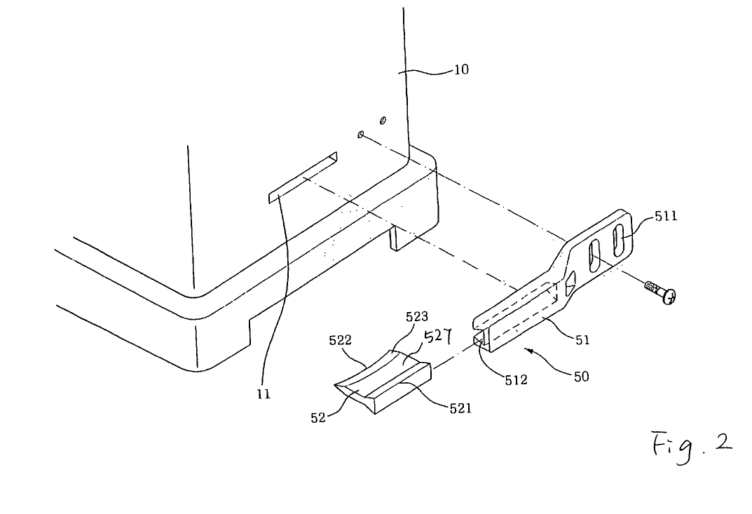

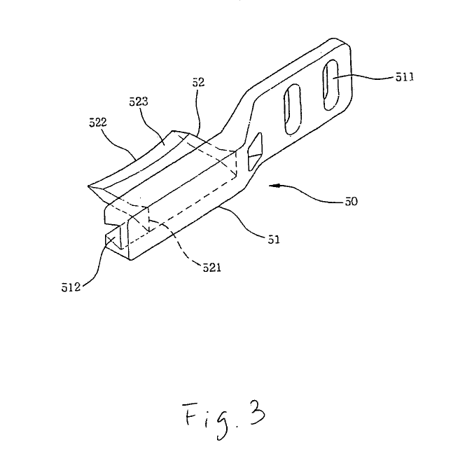

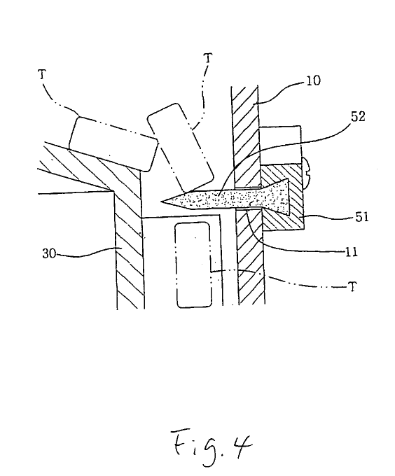

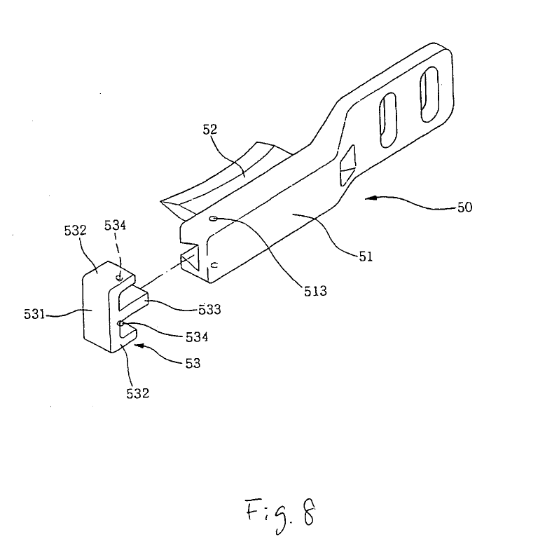

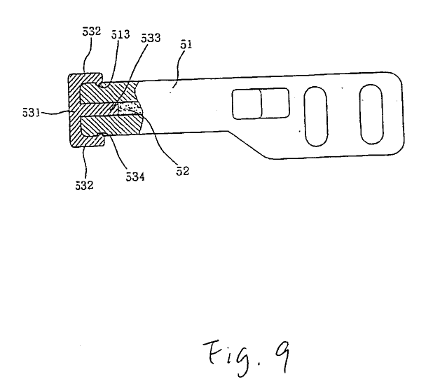

The tablet cassette 1000 may further include a partition holder 50 for holding the silicon partition 52 as shown in FIG. 8 and FIG. 9. The partition holder 50 includes a holding slit 533 for holding the silicon partition 52 and a fixing device 511 for fixing the partition holder 50 to the wall of the cylindrical confiner 10 as shown in FIG. 2, FIG. 3, FIG. 8, and FIG. 9. The cylindrical confiner 10 may include an accepting slot 11 as shown in FIG. 1, FIG. 2, FIG. 4.

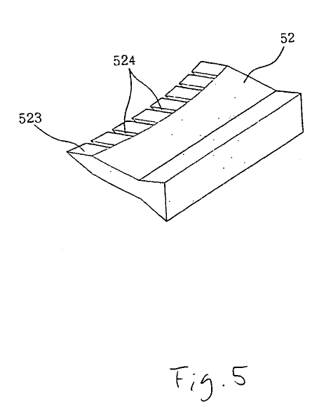

FIG. 5 shows a second embodiment of the invention, where the silicon partition 52 further includes a comb structure 524 along the dividing blade 523. The comb structure 524 reduces the stiffness of the dividing blade 523, which prevents the extra tablets from falling into the occupied slot 302 of the division block 30 and from being damaged by clogging and collision.

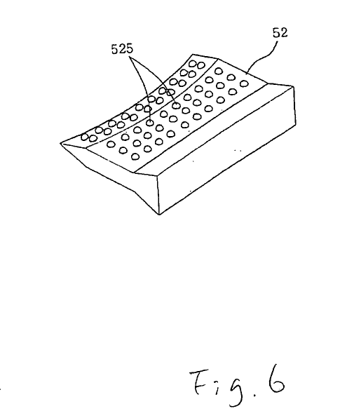

FIG. 6 shows a third embodiment of the invention, where the top surface of the dividing blade 523 and the partitioning plate 527 include a plurality of bumps 525 of a predetermined size for damping the collision between the tablet and the dividing blade 523 and the partitioning plate 527 and for increasing the collision area, wherein the predetermined size of the bumps 525 are determined by the size and shape of the tablet.

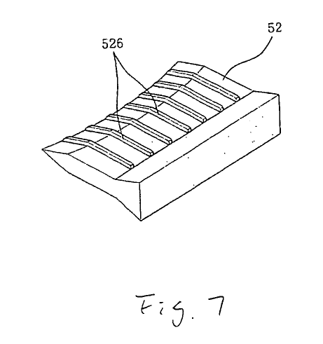

FIG. 7 shows a fourth embodiment of the invention, where the top surface of the dividing blade 523 and the partitioning plate 527 include a plurality of oblong bumps 526 in the radial direction of the division block 30 for damping the collision between the tablet and the dividing blade 523 and the partitioning plate 527 and for increasing the collision area.

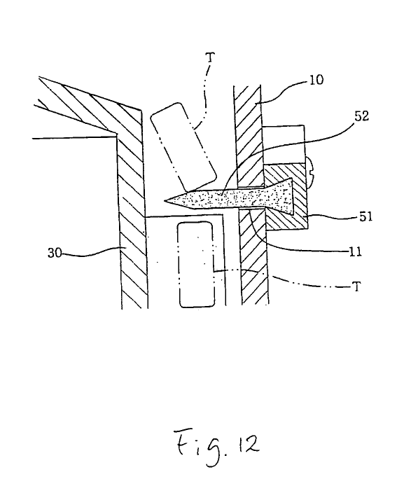

In another embodiment, the silicon partition 52 may cover at least a portion of the slot 302 of the division block 30 over the dropping hole 12 as shown in FIG. 12.

While the invention has been shown and described with reference to different embodiments thereof, it will be apprec5iated by those skilled in the art that variations in form, detail, compositions and operation may be made without departing from the spirit and scope of the invention as defined by the accompanying claims.

What is claimed is:

1. A tablet cassette with silicon partition comprising:
a) a cylindrical confiner with a bottom wall and a side wall;
b) a division block, fitted into the cylindrical confiner, with a plurality of slots, wherein the slot is disposed along a circumference of the division block and adapted to contain a tablet of a predetermined size;
c) a dropping hole bored through the bottom wall of the cylindrical confiner for passing the tablet through; and
d) a flexible partition having substantially contiguous upper surface and lower surface comprising a dividing blade, a partitioning plate, and a fixing edge, wherein the flexible partition covers the slot of the division block over the dropping hole,
wherein the flexible partition prevents tablets other than the confined tablet in the slot of the division block from entering into the slot, wherein the flexible partition bumps elastically the tablet at a side edge of the flexible partition to prevent the tablet from being damaged.

2. The tablet cassette of claim 1, wherein the flexible partition comprises a silicon patition.

3. The tablet cassette of claim 1, wherein the division block has the shape of cone, wherein the division block comprises a rotational axis, a bottom wall, and a conical top wall, wherein the conical top wall has a predetermined radial groove for facilitating dividing the downhill movement of the tablet.

4. The tablet cassette of claim 1, wherein the size of slot of the division block is determined by the size of the tablet, wherein the shape of slot of the division block is determined by the shape of the tablet.

5. The tablet cassette of claim 1, wherein the size and the shape of the dropping hole are determined by the size and the shape of the slot of the division block.

6. The tablet cassette of claim 1, wherein the dividing blade of the flexible partition has a cross-sectional shape of wedge for facilitating the vertical separation of the tablets down-poured from the above.

7. The tablet cassette of claim 6, wherein the dividing blade is elastic enough to prevent the tablet from falling into the slot below the dividing blade, wherein the dividing blade is flexible enough to prevent the tablet from being damaged from collision.

8. The tablet cassette of claim 6, wherein the inner edge of the dividing blade is circular following the inner circumferential line of the slot of the division block.

9. The tablet cassette of claim 6, wherein the thickness of the partitioning plate of the flexible partition is determined by the downward pressure of the tablets in the cylindrical confiner, wherein the thickness of the partitioning plate is determined by a predetermined stiffness for disposing the partitioning plate horizontally.

10. The tablet cassette of claim 9, wherein the thickness of the partitioning plate is approximately from 1.5 to 2.0 millimeter.

11. The tablet cassette of claim 6, wherein the fixing edge has a cross-sectional shape of wedge, wherein the dividing blade, the partitioning plate, and the fixing blade are made of silicon, wherein the dividing blade, the partitioning plate, and the fixing blade are integrated into one.

12. The tablet cassette of claim 1, wherein the division block revolves with a given angular velocity, wherein the angular velocity of the division block is controlled.

13. The tablet cassette of claim 1, wherein the division block further comprises a inter-slot barrier.

14. The tablet cassette of claim 1, wherein the thickness of the bottom wall of the division block is determined by the size and the shape of the tablet.

15. The tablet cassette of claim 1, wherein the flexible partition is disposed on the inner wall of the cylindrical confiner.

16. The tablet cassette of claim 1, further comprising a partition holder for holding the flexible partition, wherein the partition holder comprises a holding slit for holding the flexible partition and a fixing device for fixing the partition holder to the wall of the cylindrical confiner.

17. The tablet cassette of claim 1, wherein the dividing blade comprises a comb structure for reducing the stiffness of the dividing blade.

18. The tablet cassette of claim 1, wherein a top surface of the dividing blade and the partitioning plate comprise a plurality of bumps of a predetermined size for damping the collision between the tablet and the dividing blade and for increasing the collision area, wherein the predetermined size of the bumps are determined by the size and shape of the tablet.

19. The tablet cassette of claim 1, wherein a top surface of the dividing blade and the partitioning plate comprise a plurality of oblong bumps in the radial direction of the division block for damping the collision between the tablet and the dividing blade and for increasing the collision area.

20. A tablet cassette with silicon partition comprising:
a) a cylindrical confiner with a bottom wall and a side wall;
b) a division block, fitted into the cylindrical confiner, with a plurality of slots, wherein the slot is disposed along a circumference of the division block and adapted to contain a tablet of a predetermined size;
c) a dropping hole bored through the bottom wall of the cylindrical confiner for passing the tablet through; and
d) a silicon partition comprising a dividing blade, a partitioning plate, and a fixing edge, wherein the silicon partition covers at least a portion of the slot of the division block over the dropping hole,
wherein the silicon partition prevents tablets other than the confined tablet in the slot of the division block from entering into the slot, wherein the silicon partition bumps elastically the tablet at a side edge of the silicon partition to prevent the tablet from being damaged.
